(19) United States
(12) Patent Application Publication
(10) Pub. No.: US 2022/0389755 A1
(43) Pub. Date: Dec. 8, 2022

(54) COMPOSITE DOOR AND/OR WINDOW FRAMES

(71) Applicant: BBG, S.A, Esposende (PT)

(72) Inventor: Hugo Miguel MACHADO RAINHA, Esposende (PT)

(21) Appl. No.: 17/772,520

(22) PCT Filed: Oct. 30, 2019
(86) PCT No.: PCT/PT2019/050039

§ 371 Date: Apr. 28, 2022

(51) Int. Cl. E06B 3/10; E06B 3/30; E06B 3/46

(52) U.S. Cl. CPC E06B 3/105; E06B 3/303; E06B 3/46

(57) ABSTRACT

The present invention consists of a composite frames for the manufacture of doors and/or windows, which is applied in a door and/or window opening of a building and consists of at least one fixed rim (1), at least one fixed and/or movable leaf (2), and elements such as skirting boards consisting of two profiles joined together: a metal profile (5a), preferably of aluminum, covered with a second wood profile (5b), wherein these two profiles are joined by means of a glue, preferably made of polyurethane.

### SUMMARY OF THE INVENTION

The present invention consists of a composite frames for the manufacture of doors and/or windows, which is applied in a door and/or window opening of a building and consists of at least one fixed rim (1), and at least one fixed leaf and/or at least one movable leaf, wherein the fixed rim and fixed or movable leaves are made of composite material.

### FRAMEWORK OF THE INVENTION

Composite materials are materials formed by the union of other materials, thus obtaining a product with higher quality/mechanical properties. The synthesis of composite materials takes place with the mixture of compounds of different natures in order to obtain new properties for the materials. As it is a multiphase material, a composite exhibit in addition to the inherent properties of each constituent, intermediate properties that arise from the formation of an interfacial region. The phases of composites are called: i) composite matrix, which can have ceramic, polymeric and metallic origin; and ii) disperse phase, which generally has origin in fibers or particles that serve as filler.

The choice of this combination of materials relates to the following:
the aluminum, which will be the composite matrix, has excellent mechanical properties and excellent resistance to corrosion;
the wood, which will be the disperse phase, has excellent thermal and acoustic insulation properties; and
the polyurethane based adhesive is a good promoter of aluminum and wood bonding.

Thus, with the present invention we were able to obtain windows and/or doors frames with excellent mechanical properties and resistance to corrosion, which makes them to have an enormous durability, combined with the fact of having an excellent thermal and acoustic insulation, wherein these frames are not restricted to the dimensions of frames known in the state of the art as being the appropriate to be manufactured in wood.

In fact, in the current construction of all-wood frames it is not possible to manufacture openings with large dimensions or weights. With the present invention, that is, with this combination of materials, dimensions much larger than those known are achieved, being possible to manufacture large sized frames, such as 6 m² per leaf, and weights of approximately 300 kg per linear meter, which exceeds the current state of the art.

The fact that aluminum is combined with wood also makes it possible to stabilize warping and the problems of frames typically made only of wood and without a metallic structure inside it.

In turn, the fixed rim (1) can be fully integrated in the walls, ceiling or floor, and it is possible to see just at least one leaf, which has wood and glass in its constitution. The fixed rim (1), in turn, is made of aluminum and can be covered with wood in the part that is visible when the frame is mounted.

The present invention allows manufacturing frames in which only wood is visible. The front view of the vertical profiles can have a minimum of 18 mm and a maximum of 45 mm.

### BRIEF DESCRIPTION OF THE FIGURES

### Indication of the Reference Numbers:

fixed rim (1);

leaves (2);

handle (3);

wood profile (3b);

aluminum profile (3a);

vertical profile (4);

wood profile (4b);

aluminum profile (4a);

skirting boards (5);

steel bar (6);

points of the multipoint closing system (7)(8)(9);

adhesive (10);

mechanical fittings (11)(13) of the handle and the vertical profile, respectively;

screws (12).

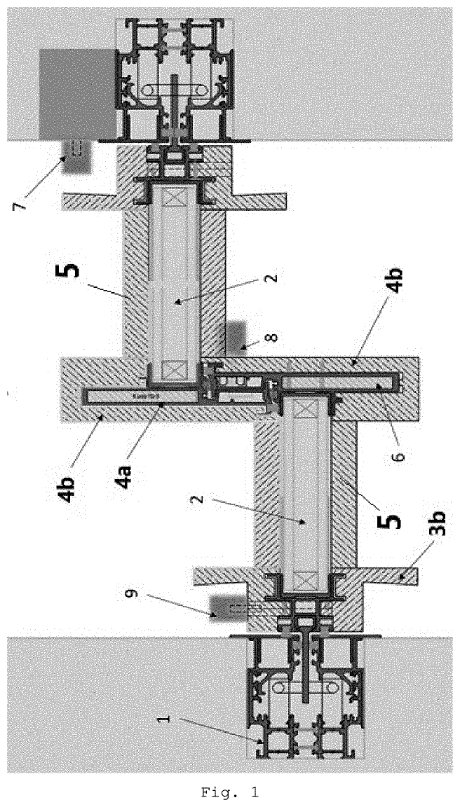

FIG. 1-Representation of a horizontal cut of the present invention, in which it is possible to identify a preferred embodiment of the invention with two leaves (2), each one having a handle (3) on their sides that attach to the fixed rim (1), presenting also a vertical profile (4) between the leaves (2) that has a steel bar (6) for reinforcement in this preferred embodiment, and the leaves (2) have skirting boards (5). All these constituents have aluminum profiles (4a) and wood profiles (3b)(4b). This FIG. also shows the possible places where the closing system can be located: on the handle (3)-point (9), on the vertical profile (4)-point (8), and on the fixed rim (1)-point (7). In all cases the closing system is multipoint.

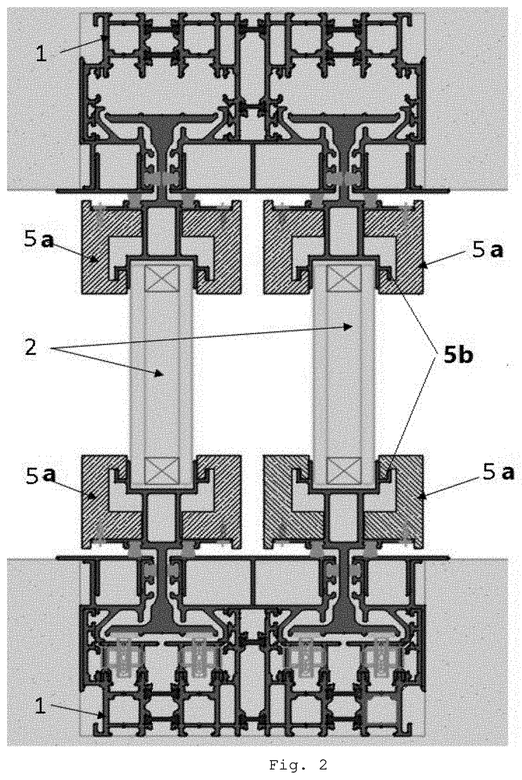

FIG. 2-Representation of a vertical cut of the present invention, in which a preferential embodiment of two movable leaves (2) is represented, in this representation the leaves (2) are overlapped, where the main objective is the representation of the skirting boards (5) and their aluminum profiles (5a) and their wood profiles (5b).

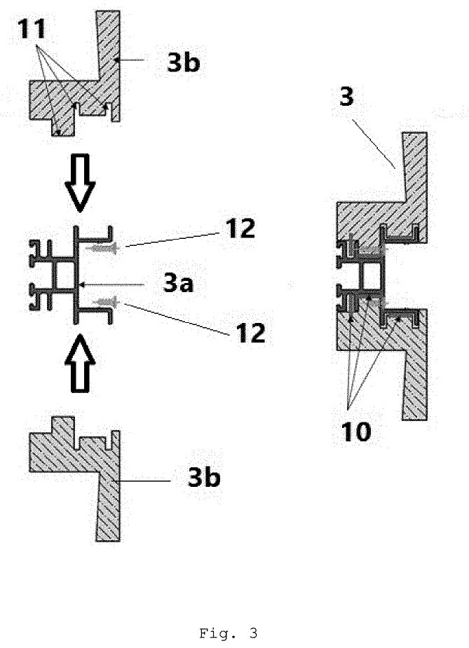

FIG. 3-Cross sectional representation of the union of the handle profiles (3), where the wood profiles (3b) and the aluminum profiles (3a) of the handle are represented, and the process of gluing these two profiles, the engagement through the handle mechanical fittings (11) and the additional tightening through the screws (12) are sketched.

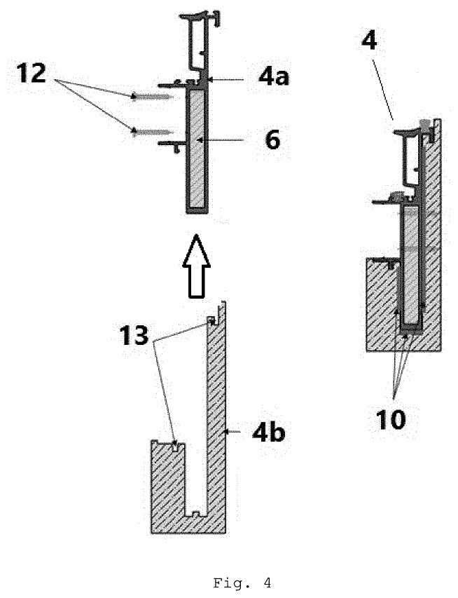

FIG. 4-Cross sectional representation of the union of the vertical profiles (4), where the wood profiles (4b) and the aluminum profiles (4a) of the vertical profile are represented, and the process of gluing these two profiles, the engagement through the vertical profile mechanical fittings (13) and the additional tightening through the screws (12) are sketched.

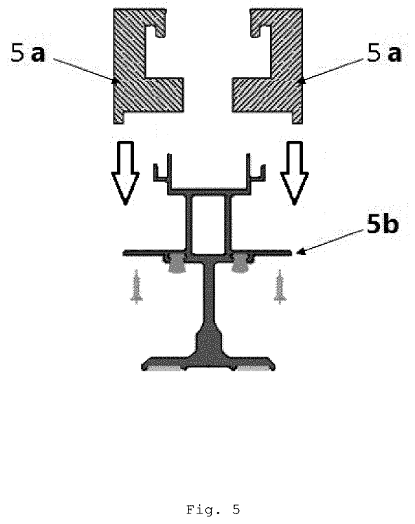

FIG. 5-Cross sectional representation of the union of the skirting board profiles (5), where the wood profiles (5b) and the aluminum profiles (5a) of a skirting board are represented, and the process of gluing these two profiles and the engagement through mechanical fittings are sketched.

DESCRIPTION OF THE INVENTION

The frames, object of the present invention, presents in its constitution at least one fixed rim (1) and at least one leaf (2), which can be fixed or movable, and which is constituted, along its perimeter, by aluminum and wood elements, either skirting boards (5), vertical profiles (4) or handles (3). The union of wood to aluminum is executed by adhesive (10) and mechanical fittings (11)(13) between the wood profiles (3b)(4b)(5b) and the aluminum profiles (3a)(4a)(5a) of the respective elements, being perimetrically fixed to the leaves (2). Screws (12) can also be used, thus ensuring an excellent adhesion and durability of the wood and aluminum profiles sets.

The leaf (2) may contain a single or double or triple glass with thicknesses between 6 mm and 38 mm, or another type of panel in another type of material. The movement of the movable leaf (2) is done through sliding in a parallel or perpendicular plane in relation to the fixed rims (1). This movement is done with the help of at least one handle (3), which is formed by aluminum profiles (3a) glued to wood profiles (3b), wherein its fixing is executed through the adhesive (10) based on polyurethane and may additionally have screws (12). Moreover, there are mechanical fittings (11) both in wood profiles (3b) and aluminum profiles (3a) to ensure good alignment between them.

In a preferred embodiment, the invention presents at least one movable leaf (2) having at least one handle (3) and at least one vertical profile (4).

In another preferred embodiment of the invention, at least one movable and/or fixed leaf (2) has skirting boards (5), in the lower and upper part of the fixed rim (1), wherein these skirting boards (5) are formed by wood profiles (5a) that are glued and screwed to aluminum profiles (5b), wherein their gluing is executed through the adhesive (10) based on polyurethane. There are also mechanical fittings both in wood profiles (5b) and aluminum profiles (5a) to ensure good alignment between them.

The vertical profile (4) has several embodiments with various sections, wherein its smallest section is 30 mm and its largest section is 45 mm. The vertical profile (4) with the smallest section is the current state of the art for wood frames. The vertical profile (4) is formed by wood profiles (4b) glued to aluminum profiles (4a), wherein their gluing is executed through the adhesive (10) based on polyurethane. The vertical profile (4) can be reinforced with a steel bar (6) inside the aluminum profile (4a), increasing the inertia of the set formed by the aluminum profile (4a) of the vertical profile and the wood profile (4b) of the vertical profile, however it is not visible. Moreover, there are mechanical fittings (13) both in wood profiles (4b) and aluminum profiles (4a) to ensure good alignment between them.

In a preferred embodiment, the closing system of the present invention is multipoint and can be applied on the fixed rim (1), on at least one leaf (2) and integrated in the vertical profile (3) or in the handle (4), having in each one of these cases its location in the points (7), (8) and (9), respectively, as shown in FIG. 1.

The fixing technique of the wood is differentiated because it combines glue with screws and fittings.

1. Composite frames for the manufacture of doors and/or windows with at least one fixed rim (1) and at least one leaf (2), which may be fixed or movable, characterized in that the leaf (2) has at least one element (3)(4)(5) along its perimeter, this element (3)(4)(5) consisting of at least one wood profile (3b)(4b)(5b), at least one aluminum profile (3a)(4a)(5a) and mechanical fittings (11)(13), wherein at least one wood profile (3b)(4b)(5b) and one aluminum profile (3a)(4a)(5a) are glued to each other by at least one adhesive (10), and in that this adhesive is based on polyurethane and the mechanical fittings (11)(13) are located between the wood profiles (3b)(4b)(5b) and the aluminum profiles (3a)(4a)(5a) of the respective elements (3)(4)(5), in order to unite the wood profiles (3b)(4b)(5b) to the aluminum profiles (3a) (4a)(5a).

2. Frames according to the previous claim, characterized in that the elements (3)(4)(5) are still joined by means of screws (12).

3. Frames according to the claim 1, characterized in that the at least one leaf (2) has at least one skirting board (5), in the lower part and/or in the upper part of the fixed rim (1).

4. Frames according to the claim 1, characterized in that the at least one leaf (2) has at least one handle (3) on its sides that are attached to the fixed rim (1).

5. Frames according to claim 1, characterized in that it has at least two leaves (2) and at least one vertical profile (4) between the leaves (2).

6. Frames according to the claim 1, characterized in that the vertical profile (4) has a steel bar (6) inside the aluminum profile (4a).

7. Frames according to the claim 1, characterized in that the vertical profile (4) has a section between 30 mm and 45 mm.

8. Frames according to the claim 1, characterized in that the closing system is multipoint and can be applied on the fixed rim (1), on at least one leaf (2) and integrated into the vertical profile (3) or the handle (4).

9. Frames according to claim 1, characterized in that the leaf (2) can contain a single or double or triple glass with thicknesses between 6 mm and 38 mm, or another type of panel in another type of material.
